(19) United States
(12) Patent Application Publication
(10) Pub. No.: US 2005/0002393 A1
(43) Pub. Date: Jan. 6, 2005

(54) Method and device for creating data packets in a packet-based data-transmission network

(75) Inventors: Roland Harend, Dusseldorf (DE); Robert Morelj, Munchen (DE); Ingo Volkening, Costa Rhu (SG)

Correspondence Address: Dicke, Billig & Czaja, PLLC;Fifth Street Towers, Suite 2250, 100 South Fifth Street, Minneapolis, MN, 55402, US

(73) Assignee: Infineon Technologies AG

(21) Appl. No.: 10/848,927

(22) Filed: May 19, 2004

(30) Foreign Application Priority Data
May 20, 2003 (DE) 103 22 707.5

(51) Int. Cl. H04L 12/56

(52) U.S. Cl. 370/389; 370/469

(57) ABSTRACT

A method for transmitting data packets via a connection in a packet-based data-transmission network. The method includes creating the data packets such that each comprise useful data and packet data containing information items necessary for the transmitting. The method also includes creating the packet data of the data packets at least partly from memory packet data that have been previously stored for the connection.

### CROSS-REFERENCE TO RELATED APPLICATIONS

This Utility Patent Application claims priority to German Patent Application No. DE 103 22 707.5, filed on May 20, 2003, which is incorporated herein by reference.

### BACKGROUND

The present invention relates to a method for creating data packets for transmission in a packet-based data-transmission network and also to a device designed to perform the method.

In the transmission of data packets via data-transmission networks, delays, jitter or propagation-time fluctuation and losses of packets occur disadvantageously. In principle, the data packets contain both the useful data to be transmitted and also additional packet data containing information items that are necessary for the transmission. The packet data may relate, in particular, to the transmitter and the receiver and the type of data to be transmitted. Furthermore, checksums are transmitted as packet data in order to detect transmission errors. If the data packets are transmitted via network nodes, every network node has to analyze and process the data packets in accordance with the required service. This results in an impairment of the transmission quality, in particular in regard to the delay and the jitter. However, this is of fundamental importance, in particular for real-time applications. Real-time applications are basically applications in which time constraints govern the transmission of the individual data packets and, in particular, a data transmission that is as free of delay as possible must be ensured. In particular, such applications are telephoning or faxing via data-transmission networks or the transmission of music or video data via data-transmission networks.

### SUMMARY

In one embodiment of the present invention, provided are a method and a device designed to perform the method of the type mentioned at the outset, wherein the quality of the data transmission, in particular for real-time data, is improved and, in addition, the transmission speed can be increased.

According to one embodiment of the invention, the packet data are at least partly created from memory packet data that have been previously stored for the connection concerned. In this connection, the present invention makes use of the fact that, in the transmission of data packets in the framework of a particular connection, many packet data remain identical or similar. Instead of recalculating all the packet data for every data packet as at present in the prior art, packet data are used in the form of memory packet data that have been stored beforehand for the particular connection. The effort expended on generating the packet data and, consequently, the time necessary to create the data packets can consequently be reduced, memory packet data or parts thereof being adopted to determine the packet data so that no computational effort or a reduced computational effort is necessary to create the packet data. Such a procedure may be used in the case of real-time data since the transmission time and the jitter of the transmission time or fluctuations in the transmission time can be reduced by a more rapid determination of the data packets.

The packet data are calculated and additionally stored immediately after setting up the connection for the first data packets and only the first data packet. The subsequent data packets of said connection are, however, already created by the method according to the invention, in which process the stored packet data are used. The packet data are determined in a conventional way, for example, by executing a stack of protocol layers. In this process, packet data are added to the useful data for every protocol layer executed. In this connection, the packet data are distributed, for example, over various fields that correspond to the individual protocol layers. The fields can be placed in front of the useful data in the form of headers or attached behind the useful data in the form of trailers.

In one embodiment of the present invention, a connection generally corresponds to the data traffic between certain components of the data-transmission network.

The packet data distributed in the data fields are stored field-by-field as memory packet data so that the data are stored in separate fields in accordance with the individual protocol layers.

In one embodiment, the data packets are transmitted over the Ethernet so that a protocol layer comprises the addition of Ethernet packet data. Furthermore, one layer may regulate the addition of IP packet data and a further layer may relate to the addition of UDP packet data that describe the nature of the data and the application using said data.

In one application case, a field containing RTP (real-time protocol) packet data that indicates that it is real-time data is attached to the useful data.

In one device for performing the method according to the invention, the various packet information items of various components can be added. Thus, for example, provision may be made that the useful data are read in analog form at a physical connection and then converted into digital values by an analog/digital conversion. A component for the conversion into digital values may furthermore add, for example, the RTP data since, under some circumstances, it may already be certain at this point that real-time data are involved. In one application case for this is the transmission of television, audio or video data over a data-transmission network, in which case an analog or digital telephone whose output signals are optionally converted into digital values in the device and then provided with the RTP packet data may be connected to the physical terminal of the device in the case of a telephone connection. The other packet data may be added by a further component, for example, an auxiliary processor, by the method according to one embodiment of the invention.

To calculate the packet data stored as memory packet data, use may be made of a processor that, as a result of executing the protocol layers, is capable of determining the packet data in accordance with the prior art. Said processor may also be used to generate the data packets from the memory packet data.

In one embodiment, a plurality of processors may also be used that can be broken down, for example, into a main processor and at least one auxiliary processor. In this connection, the main processor can be used, as described above, to calculate the packet data on the basis of the protocol layers and an auxiliary processor can be used to generate the data packets on the basis of the memory packet data in accordance with the invention, in which connection an interface chip may be additionally provided as a connection to a connected telephone.

The interface chip has an analog/digital converter and a digital/analog converter so that an analog telephone can be connected. Furthermore, the interface chip is designed in such a way that it can add data, present in digital form, of the analog data telephone to packet data in the form of an RTP header. The interface chip consequently provides digital useful data that have already been extended by packet data.

In this connection, the data supplied by the interface chip may also contain items of information about the number dialed at the telephone or function keys pressed at the telephone. Before the connection is set up, the data supplied by the interface chip are processed by the main processor, which adds the packet data in accordance with the required protocol layers and transmits the data packets. As soon as the data packets have been calculated for the first data packets, they are stored in a memory as memory packet data that the auxiliary processor can access. In this connection, not all the packet data have necessarily to be stored. For example, packet data that are already added by the interface chip do not have to be stored. Furthermore, it may also be expedient, under some circumstances, not to store some packet data, but to recalculate them every time if said packet data are modified into individual data packets during the transmission over a connection and would not yield any calculation advantage if stored packet data are used.

In one device for performing the method, at least one physical terminal, which may be, for example, a terminal for a telephone or a camera, may be present for reading-in the useful data. For the useful data that are read in via said physical terminal, the conclusion can consequently already be drawn that they originate from at least one specific component that is connected to the physical terminal. Said conclusion may be used to create the packet data if it is known which component is connected to said physical terminal. For example, a plurality of physical terminals may be provided to each of which a telephone is connected. Consequently, the information about the connected subscriber can be assigned to each physical terminal and the useful data entering via said terminal, and the useful data can be provided with appropriate packet data.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates the structure of an arrangement for the transmission of telephone data via a data-transmission network having a device for creating data packets in accordance with the embodiment of the present invention.

FIG. 2 illustrates the structure of the device for creating data packets in accordance with the embodiment of the present invention.

FIG. 3 diagrammatically illustrates the structure of a data packet.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

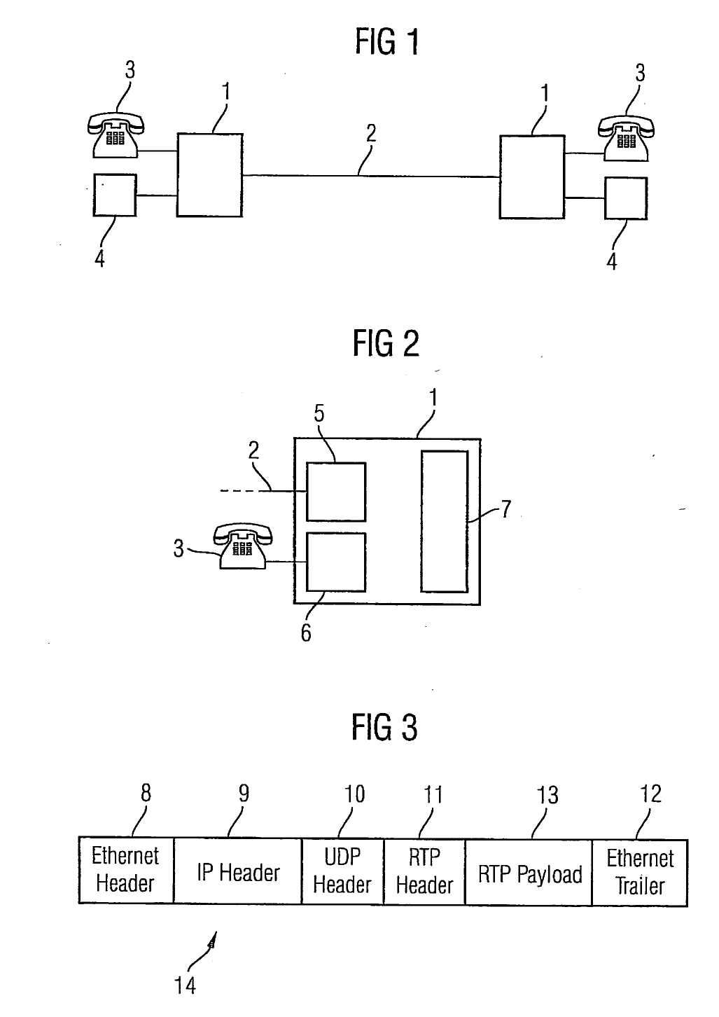

FIG. 1 illustrates diagrammatically an arrangement for the transmission of telephone data via a data-transmission network 2. The telephone data are received or transmitted by analog telephones 3. In this case, the telephones 3 are connected to gateways 1 that are connected to the data-transmission network 2. The data-transmission network 2 may be based on IP, ATM, Ethernet, HDLC or frame relay, or on combinations thereof. Basically, the data-transmission network 2 is packet-based in the broadest sense so that the data are transmitted in the form of data packets. Additionally connected to every gateway 1 is a personal computer 4 that can likewise transmit or receive data via the data-transmission network 2. The personal computers 4 are connected via standard network cards or Ethernet terminals to the gateway 1.

The gateways 1 have the task of conveying incoming data from the connected telephone 3 and the connected personal computer 4 to the data-transmission network 2 and of forwarding data packets received from the data-transmission network 2 in the correct way to the telephone 3 or to the personal computer 4. In regard to the data traffic between the personal computer 4 and the data-transmission network 2, the gateway 1 functions as a normal gating circuit if the personal computer 4 already has the necessary means for creating data packets or analyzing incoming data packets.

In the case of the telephone 3, however, the gateway 1 has to process the data received from the telephone 3 in such a way that data packets are ultimately produced that can be transmitted via the data-transmission network 2. Conversely, the gateway 1 has to receive data packets that are transmitted to the telephone 3 and process them to form signals that can be processed by the telephone 3. This includes, in particular, an analog/digital conversion or digital/analog conversion.

The evaluation of the data supplied by the telephone 3 also includes the recognition of a number dialed at the telephone 3 or a function key pressed at the telephone 3. The number dialed at the telephone 3 is used by the gateway 1 to obtain the necessary information items about the recipient to whom the data following in said connection of the telephone 3 have to be sent. One embodiment of the present invention relates to the transmission of data packets in the framework of a connection. In the present case of the transmission of telephone data via a data-transmission network 2, a connection can be equated to a call between subscribers who remain the same, in which case conference connections may also be included. However, as soon as the group of subscribers changes, this corresponds, in the context of one embodiment of the present invention, to a new connection for which the method according to the invention has to be performed again.

FIG. 2 illustrates diagrammatically the structure of a gateway 1. In this connection, the gateway 1 comprises a main processor 7, a first auxiliary processor 5 and a second auxiliary processor 6. The first auxiliary processor 5 is connected to the data-transmission network 2 and the second auxiliary processor 6 is connected to the telephone 3. The main processor 7 and the two auxiliary processors 5, 6 are interconnected so that they can exchange data with one another. The gateway 1 furthermore has memory devices that the main processor 7 and the two auxiliary processors 5, 6 can access either alone or jointly. The personal computer 4 may be connected at the gateway 1 either to the first auxiliary processor 5 or to the main processor 7.

FIG. 3 diagrammatically illustrates a data packet 14 for the transmission of telephone data of the telephone 3 over the data-transmission network 2. The core of the data packet 14 is the useful data 13, which are described as RTP payload. The term RTP stands for real time protocol and characterizes the useful data 13 as real-time data. FIG. 3 already shows the data packet 14 in the form that is suitable for transmission via the data-transmission network 2, i.e. with all the necessary packet data. The packet data are divided up into individual packet fields 8 to 12. During the creation of such a data packet 14, a stack of protocol layers is run through proceeding from the useful data 13 and a part of the packet data is added for each protocol layer. In the present case, at least one packet-data field 8 to 12 is added for each protocol layer, the added packet-data fields being attached at the front and/or at the rear. For some of said packet data, it is necessary for the gateway 1 to make contact with other network components not shown in order to be able to provide the necessary information items for the packet-data fields. This is the case, in particular, for information items that relate to the receiver or the transmission path to the receiver.

In the present case, the packet-data fields 8 to 12 correspond to the data fields occurring in an H.323 data packet. The necessary protocol layers for generating said data fields can be processed by the main processor 7, which can consequently create the packet data during the setting up of a connection.

The information items incoming from the telephone 3 reach the second auxiliary processor 6 in analog form, are connected in the latter to digital values and provided with the RTP header 11. During the setting up of the connection, the further packet-data fields 8, 9, 10 and 12 are added by the processor 7 as a result of processing the protocol layer. However, this is performed only for the first data packet 14. The packet data calculated by the main processor 7 are stored in a memory as memory packet data.

All the further data packets 14 that belong to the same connection are now created without involving the main processor 7 solely by the second auxiliary processor 6. For this purpose, the latter accesses the memory packet data and adds them to the useful data 13 together with the RTP header 11. In this connection, the case may occur under some circumstances that the stored packet data 8 to 12 cannot be transferred unaltered, but have first to be adapted. This may be the case, for example, for checksums.

The setting up of a connection and the creation of data packets 14 in the process are described below. In the present case, the connection is set up by lifting the handset of a telephone 3 and dialing a number on said telephone 3. The dialing of the number is evaluated by the second auxiliary processor 6 and passed to the main processor 7. The latter first requests via the data-transmission network 2 information items that correspond to the receiver or the dialed number. The first data awaiting transmission are in the form of useful data 13, the RTP header 11 already being attached at the front by the second auxiliary processor 6. The main processor 7 now runs through the appropriate stack of protocol layers in order to create the complete data packet 14. The data packet obtained in this way is transmitted via the data-transmission network 2. In the present embodiment, only a single connection between two gateways is depicted as data-transmission network 2. In reality, however, the data-transmission network 2 may comprise substantially more subscribers and additional branching components. Thus, in reality, hubs, routers or other components may be looped in between the two gateways involved.

The subsequent data packets 14 from the gateway 1 are now no longer created by the main processor 7. The incoming useful data 13 for transmission in subsequent data packets 14 are provided directly with the stored memory packet data by the second auxiliary processor 6 and immediately passed via the first auxiliary processor 5 to the data-transmission network 2. In this connection, the memory packet data may be modified either by the second auxiliary processor 6 or, alternatively, by the first auxiliary processor 5 if the packet data in stored form cannot be used in unaltered form for the data packet 14 currently to be transmitted. The memory packet data must in that case be adapted accordingly.

In a variant of the embodiment, the functionality of the second auxiliary processor 6 can be distributed over two components. For this purpose, there may be assigned to the second auxiliary processor 6 a telephone interface via which the second auxiliary processor is connected to the telephone 3 and into which some functions may be swapped out. These may be, in particular, the analog/digital conversion, the digital/analog conversion or the coding/decoding. In addition, the telephone interface may also generate the RTP data packets including the RTP packet data.

Consequently, with the aid of the present invention, it is possible to package the useful data 13 arriving from the telephone 3 with particularly little effort and, consequently, particularly little time delay into data packets 14 so that the useful data 13 can be exchanged between the two telephones 3 with little delay and little jitter.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A method for transmitting data packets via a connection in a packet-based data-transmission network, comprising:
creating the data packets such that each comprise useful data and packet data containing information items necessary for the transmitting; and
creating the packet data of the data packets at least partly from memory packet data that have been previously stored for the connection.

2. The method of claim 1, further comprising calculating the packet data for at least one data packet in accordance with a stack of protocol layers in the data-transmission network and storing packet data for at least one data packet as memory packet data for the connection.

3. The method of claim 2, characterized in that after setting up the connection, at least a first data packet is not transmitted via the data-transmission network.

4. The method of claim 2, further comprising calculating the packet data by a main processor in accordance with a stack of protocol layers and creating data packets by an auxiliary processor using memory packet data.

5. The method of claim 1, further comprising subdividing the packet data into packet-data fields.

6. The method of claim 1, characterized in that the packet data meet the requirements of protocol layers.

7. The method of claim 1, further comprising transferring the memory packet data at least in part unaltered to the packet data of the data packets.

8. The method of claim 1, further comprising altering the memory packet data at least in part as a function of the useful data and the connection and transferring the memory packet data in altered form to the data packets.

9. The method of claim 1, further comprising altering the memory packet data at least in part as a function of the useful data or the connection and transferring the memory packet data in altered form to the data packets.

10. The method of claim 1, characterized in that the useful data contain speech data, audio data or video data.

11. The method of claim 1, characterized in that the connection is a telephone connection or a fax connection.

12. The method of claim 1, further comprising providing the useful data with packet data in accordance with a real-time protocol.

13. The method of claim 1, further comprising providing the useful data with packet data in accordance with an IP protocol.

14. The method of claim 1, characterized in that the data-transmission network is selected from a group comprising an Ethernet, HDLC, frame-relay, IP network, and an ATM network.

15. The method of claim 1, further comprising reading the useful data in via a physical terminal and creating the packet data at least in part as a function of the terminal via which the useful data are read in.

16. A device for transmission of data packets via a connection in a packet-based data-transmission network comprising:
means for creating the data packets, which each comprise useful data and packet data containing information items necessary for the transmission;
and means for creating the packet data of the data packets at least in part from the memory packet data stored for the connection.

17. The device of claim 16, characterized in that the packet data for at least one data packet are calculated in accordance with a stack of protocol layers in the data-transmission network and are stored as memory packet data for the connection.

18. The device of claim 16, characterized in that after setting up the connection, at least a first data packet is not transmitted via the data-transmission network.

19. The device of claim 16, characterized in that the packet data are calculated by a main processor in accordance with a stack of protocol layers and data packets are created by an auxiliary processor using memory packet data.

20. The device of claim 16, characterized in that the packet data are subdivided into packet-data fields.
